(19) United States
(12) Patent Application Publication
(10) Pub. No.: US 2021/0332257 A1
(43) Pub. Date: Oct. 28, 2021

(54) PROTECTIVE COATING FOR SUBSTRATE AND PREPARATION METHOD THEREFOR

(71) Applicants: No.59 Institute of China Ordnance Industry, Chongqing (CN); University of Science and Technology Liaoning, Anshan (CN)

(72) Inventors: Hulin WU, Chongqing (CN); Lunwu ZHANG, Chongqing (CN); Zhiwen XIE, Anshan (CN); Qiang CHEN, Chongqing (CN); Xu GAO, Anshan (CN); Yongjun CHEN, Anshan (CN); Lin XIANG, Chongqing (CN); Haiqing NING, Chongqing (CN); Yong ZHONG, Chongqing (CN); Suying HU, Anshan (CN); Shuai WU, Chongqing (CN); Bo FENG, Anshan (CN); Hong SU, Chongqing (CN); Xiaohui WANG, Chongqing (CN); Bo HUANG, Chongqing (CN); Di WU, Anshan (CN)

(21) Appl. No.: 16/987,891

(22) Filed: Aug. 7, 2020

(30) Foreign Application Priority Data
Apr. 26, 2020 (CN) 202010338488.4

(51) Int. Cl. C09D 127/18; B05D 1/00; B05D 1/10; B05D 3/12; C09D 1/00

(52) U.S. Cl. CPC C09D 127/18; B05D 1/62; C09D 1/00; B05D 3/12; B05D 1/10

(57) ABSTRACT

A wear-resistant super-hydrophobic protective coating for a substrate includes a pretreated surface and a composite coating. The composite coating is formed of a mixture of a ZrO₂ powder, a PTFE powder and a silicone powder by spraying. A method for preparing the protective coating on a substrate is also provided.

### CROSS-REFERENCE TO RELATED APPLICATION

This application claims the benefit of priority from Chinese Patent Application No. 202010338488.4, filed on Apr. 26, 2020. The content of the aforementioned application, including any intervening amendments thereto, is incorporated herein by reference in its entirety.

### TECHNICAL FIELD

This application relates to plasma spray coating featuring coating materials, and more particularly to a wear-resistant super-hydrophobic protective coating for a substrate and a preparation method therefor.

### BACKGROUND OF THE DISCLOSURE

Seawater is the most abundant natural electrolyte. Various metal structures, such as seagoing vessel, steel harbor wharf, offshore production platform, submarine cable and seawater cooler, are generally soaked in the seawater or the ocean-atmosphere environment, inevitably suffering from electrochemical corrosions caused by the seawater (Song X, Seawater Corrosion and Protection of Metal Materials, Materials for Mechanical Engineering, 1983, 2, 58-61).

Due to an average salinity of 3.5% and the existence of other impurities, metal ions such as sodium, magnesium and calcium ions, and non-metallic ions such as chloride and sulfide ions, the seawater itself is a strong electrolyte, and will form a chemical battery with proper electrodes to cause the metal materials, such as steel, to suffer from electrochemical corrosion. Moreover, the mediums in the seawater will also react with the steel, resulting in the corrosion of the metal substrates (Liu X, Anticorrosion Coating Technology and Its Progress in Ocean Environment, Modern Paint & Finishing, 2010, 13(4), 25-27). Besides, a large number of chloride ions in the seawater will not only pass through the surface corrosion products to accelerate the dissolution of the anodic substrate such as steel, but also inhibit the adsorption of the corrosion products to promote the surface corrosion products to fall off, which renders the outer rust layer loose, so that it is hard to form a dense protective rust layer on the metal surface, greatly aggravating the corrosion of the substrate in the seawater. Therefore, in the ocean-atmosphere environment, the metal mechanical elements are prone to surface corrosion, allowing for greatly shortened service life and higher occurrence rate of accident.

Generally, zirconium dioxide (ZrO₂) is a white, odorless and tasteless crystal, and is poorly soluble in water, hydrochloric acid and diluted sulphuric acid. In addition, it also has a high melting point, a large electrical resistivity and a low expansion coefficient, so that it is widely used in ceramic, ceramic glaze, grinding media, fuel cell and optical recording material (Wei L, Preparation and Application of Zirconium Dioxide, Hebei Ceramic, 1999, 27(2), 29-31).

Polytetrafluoroethylene (PTFE), also named teflon and polytef, has excellent resistance to low and high temperature, chemical stability, electrical insulating property, adhesion, weatherability, flame resistance and self lubrication, and thus it is widely used in the fields of national defense, aerospace, petrochemical engineering, electronic engineering and mechanical engineering (Liu T, et al., Progress in Meltable Processing Research of Polytetrafluoroethylene, Engineering Plastics Application, 2010, 38(5), 89-91).

Silicone, also named silicone oil or dimethyl silicon oil, is an open-chain and cyclic organic compound carrying a —SiR2O— group, and has a controllable solubility, a high thermal stability and a low toxicity, and thus it is widely used in foam, release paper, flame retardant, fabric, coating material and agriculture (Zheng W, Application of Silicone Surfactant, Advances in Fine Petrochemicals, 2003, 4(1), 39-43).

Currently, there is no report about the composite coating of ZrO₂, PTFE and silicone, and the related product is not commercially available.

### SUMMARY OF THE DISCLOSURE

To overcome the defects in the prior art, an object of the disclosure is to provide a protective coating with excellent corrosion resistance for a substrate.

It has been found that there are technical obstacles in the one-step preparation of a composite of ZrO₂, PTFE and silicone, which are specifically described as follows: (1) ZrO₂ is greatly different from PTFE in the melting point, where ZrO₂ has a melting point of 2715° C. (Wei L, Preparation and Application of Zirconium Dioxide, Hebei Ceramic, 1999, 27(2), 29-31), while PTFE has a melting point of 327° C. (Xie S, Modification and Application of PTFE, New Chemical Materials, 2002, 30(11), 26-30), so that when ZrO₂ starts to melt, PTFE may have already been burned out; (2) Ceramic material ZrO₂ has poor binding to the macromolecular PTFE, so even ZrO₂ and PTFE can be compounded to produce a coating, the coating generally has a layered structure and is prone to falling off the substrate.

To achieve the above object, the disclosure adopts the following technical solutions.

The disclosure provides a protective coating for a substrate, comprising: a pretreated surface and a composite coating, wherein the composite coating is formed of a mixture of a ZrO₂ powder, a PTFE powder and a silicone powder by spraying.

In some embodiments, the pretreated surface has a rough structure.

In some embodiments, a weight ratio of the ZrO₂ powder to the PTFE powder to the silicone powder is 9-11:0.9-1.1:0.45-0.55.

In some embodiments, the ZrO₂ powder contains 7%-9% by weight of yttrium oxide.

In some embodiments, the ZrO₂ powder has a particle size of 11-125 μm; the PTFE powder has a particle size of 20-60 μm; and the silicone powder has a particle size of 4.0-4.5 μm.

In some embodiments, the substrate is a metal or a ceramic material.

In some embodiments, the composite coating has a thickness of 10-40 μm.

The disclosure further provides a method for preparing the protective coating for a substrate, comprising:

subjecting the substrate to sand blasting to produce the pretreated surface; and

spraying the mixture of the ZrO₂ powder, the PTFE powder and the silicone powder onto the substrate by air plasma spraying.

In some embodiments, the method for preparing the protective coating further comprises:

mixing the mixture for 2-2.5 h in a rolling-type ball mill; drying the mixture at 90-95° C. in a drying oven for 1-1.5 h; cooling the mixture; and spraying the cooled mixture onto a surface of the substrate with a spray gun;

wherein a moving speed of the spray gun is 440-460 mm/s.

In some embodiments, parameters of the air plasma spraying are set as follows: current: 530-570 A; voltage: 40-50V; power: 20-27.5 KW; compressed air: 0.6-0.7 MPa; feeding rate of carrier gas: 4-6 L/min; feeding rate of the mixture: 20-28 g/min; and spraying distance: 109-111 mm.

In some embodiments, the carrier gas is argon.

The disclosure has the following beneficial effects.

The coating provided herein has a good and stable super-hydrophobicity and chemical property, and excellent resistances to corrosion, wear and high temperature. The coating is not easy to fall off from the substrate surface due to the nonlayered structure. The disclosure overcomes the technical obstacles in the prior art that it fails to form a composite of ZrO₂, PTFE and silicone by one step. The coating provided herein is suitable not only for the protection of substrates in normal environments, but also particularly for the coating of the surface of various workpieces in marine environments. The method for preparing the coating in this disclosure has simple process, high efficiency and low cost, and thus it is beneficial to the industrial production.

### BRIEF DESCRIPTION OF THE DRAWINGS

FIG. 1 is an XRD (X-ray diffraction) pattern of a protective coating according to Example 1 of the present disclosure to show its components, in which AUTS is austenite.

FIG. 2 is an SEM (scanning electron microscope) image showing a surface of the coating and test results of hydrophobicity of the coating according to Example 1 of the present disclosure.

FIG. 3 is a sectional micrograph of the coating along a vertical direction according to Example 1 of the present disclosure.

FIGS. 4A-D schematically show the characterization of wear resistance of the coating according to Example 1 in the present disclosure; FIG. 4A shows a friction coefficient curve of substrates with and without the coating; FIG. 4B is a profile diagram and a hyperfocal diagram of the substrate without the coating; FIG. 4C is a profile diagram and a hyperfocal diagram of the coating; and FIG. 4D schematically shows wear rates of the substrates with and without the coating; in which 316L is the substrate without the coating.

FIG. 5 shows curves of open circuit potentials respectively of the substrate with and without the coating over time according to Example 1 in the present disclosure.

### DETAILED DESCRIPTION OF EMBODIMENTS

The following embodiments are merely illustrative of the disclosure, and are not intended to limit the disclosure. Various variations and modifications made by those skilled in the art without paying any creative effort should fall within the scope of the disclosure.

### Example 1

Provided herein was a protective coating for a substrate used in marine environment, where the coating was prepared according to the following steps.

(A) Pretreatment

(A1) A 316L stainless steel workpiece with a diameter Φ of 25 mm and a thickness of 6 mm was carefully polished with abrasive paper to remove the rags, welding slags, sharp and acute corners on the surface and then used as a substrate.

(A2) A granular and multangular white alundum abradant with a particle size of 150 mesh was sprayed onto the surface of the substrate in step A1 at a high speed to completely eliminate impurities on the surface and roughen the surface, where 0.67 MPa dry clean compressed air was used as power; a spray distance was 150 mm; and a spray angle was 45°-90°.

(B) Preparation of a Composite Coating

(B1) 200 g of ZrO₂ powder having a particle size of 68 μm (the ZrO₂ powder contained 8% by weight of yttrium oxide), 20 g of PTFE powder having a particle size of 40 μm and 1 g of silicone powder having a particle size of 4.3 μm were mixed evenly in a rolling-type ball mill for 2 h, dried at 90° C. in a drying oven for 1 h and cooled to room temperature to produce a mixed powder.

(B2) The mixed powder obtained in step (B1) was sprayed uniformly onto the surface of the substrate using a powder feeder through air plasma spraying, where a F4 spray gun was used, and the air plasma spraying was carried out under the conditions of: moving speed of the F4 spray gun: 440-460 mm/s; current: 550 A; voltage: 45 V; power: 24.8 KW; compressed air: 0.67 MPa; feeding rate of carrier gas: 4 L/min; feeding rate of the mixed powder: 24 g/min; and spraying distance: 110 mm. There was no need to subject the substrate coated with the mixed powder to heat insulation.

The mixed powder was fed by the powder feeder to the flame to be melted, and then the melted powder was speeded up by the flame fluid to 150 m/s to be sprayed on the substrate to form the coating.

Property Measurement

The properties of the coating prepared in Example 1 were measured as follows.

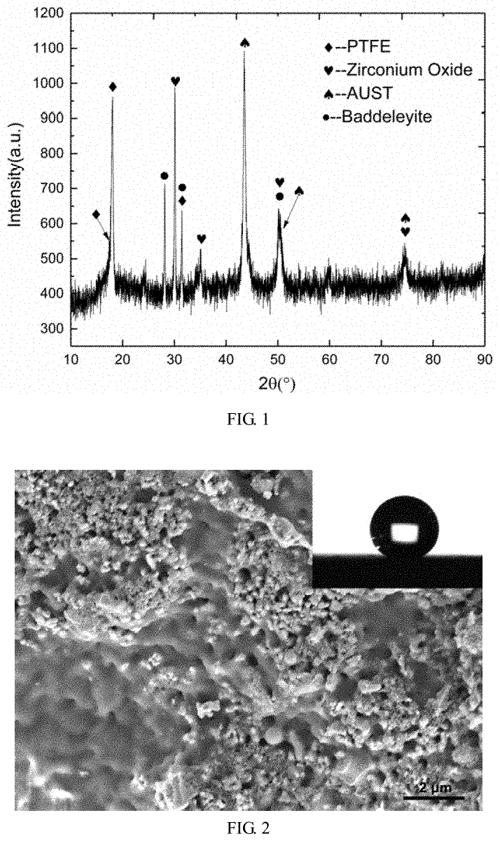

The phase structure of the coating was analyzed using an X′Pert Powder X-ray diffractometer with a scanning range of 10°-90°, and the result was shown in FIG. 1.

As shown in FIG. 1, the coating was composed of PTFE, ZrO₂ and baddeleyite. The occurrence of an austenite diffraction peak was caused by the use of a general angle for diffraction. The coating contained two forms of ZrO₂. ZrO₂ is monoclinic under normal pressure, i.e. baddeleyite. It can be seen from FIG. 1 that most of the mixed powder was melted after passing through the plasma flame fluid, and the melted ZrO₂ existed in two phases, i.e. tetragonal phase and cubic phase, which had the same peak.

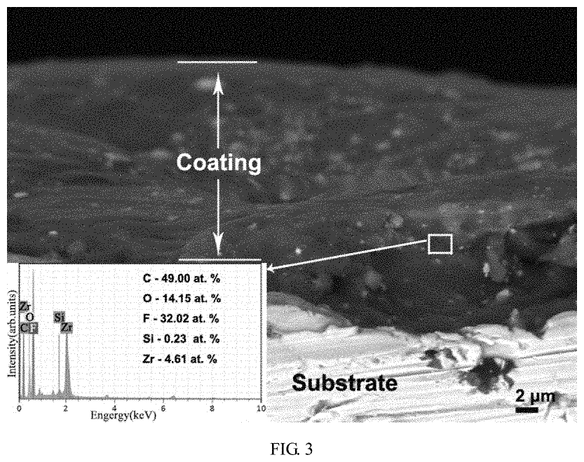

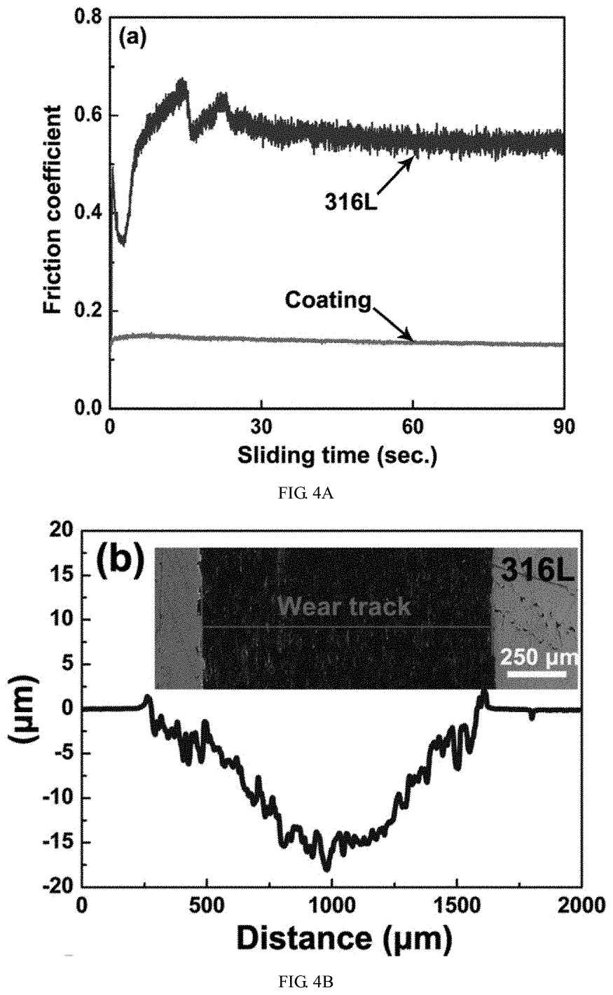

The surface and cross sectional morphologies of the coating prepared in Example 1 were observed using Zeiss-ΣIGMAHD field emission scanning electron microscope, and whether the water drops can become spherical on the coating was also observed. The results were shown in FIGS. 2 and 3, where FIG. 2 was an SEM image showing the surface of the coating and test results of hydrophobicity of the coating, and FIG. 3 was a sectional view of the coating.

As shown in FIG. 2, when the water drops were placed on a rough surface, the air will be blocked in the holes to form a protective cushion, so that the water can only contact with the top of the convex, and failed to moisten the whole surface. Therefore, the coating in this disclosure has a super hydrophobicity.

As shown in FIG. 2, the surface of the coating has a rough structure, on which there were a lot of nanoscale holes.

As shown in FIG. 3, the coating had a thickness of about 12 μm, and recessed structures can be obviously observed on the surface of the coating, which further supported the super hydrophobicity of the rough surface of the coating. It can be seen from the energy disperse spectroscopy (EDS) image that the coating was mainly formed by PTFE, and then filled with zirconia ceramic, and the dispersion of elements were enhanced, i.e. the coating had a nonlayered structure.

The hydrophobicity of the coating was tested by observing whether the water drops were spherical on the surface of the coating once every five days for a total of six times. There was almost no change occurring in the hydrophobicity, which indicated that the hydrophobicity of the coating was stable.

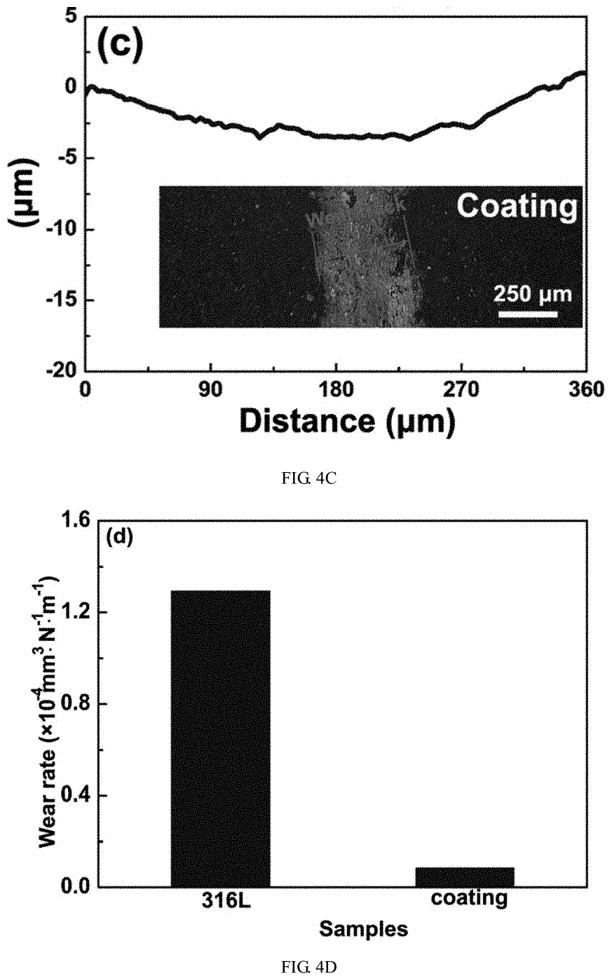

The friction and wear resistances of the coating and the pre-treated substrate without the coating were tested by MS-T3000 friction-wear testing machine with a GCr15 stainless steel ball with a diameter of 6 mm as the friction pair, where the test was operated under the conditions of: rotating speed: 200 rap/min; rotating diameter: 8 mm; load: 5 N; and test time: 90 min. The section profile of the wear respectively on the pre-treated substrates with and without the coating was measured by ALPHASTEP D-100 step profiler with a scanning length of 2500 μm and a scanning speed of 0.1 mm/sec. FIGS. 4A-D schematically showed the characterization of wear resistance of the coating according to Example 1 in the present disclosure; where FIG. 4A showed a friction coefficient curve of substrates with and without the coating; FIG. 4B was a profile diagram and a hyperfocal diagram of the substrate without the coating; FIG. 4C was a profile diagram and a hyperfocal diagram of the coating; FIG. 4D schematically showed wear rates of the substrates with and without the coating; in which 316L was the substrate without the coating.

As shown in FIGS. 4a-4d, the substrate without the coating had a friction coefficient of 0.554, and the substrate with the coating had a friction coefficient of 0.139; the substrate without the coating had a wear rate of 1.293*10⁻⁴ mm³·N⁻¹·m⁻¹, and the substrate with the coating had a wear rate of 1.469*10⁻⁵ mm³·N⁻¹·m⁻¹. Therefore, the coating had an excellent wear resistance.

The substrates with and without the coating were respectively subjected to corrosion resistance test to obtain the open circuit potential-time curve using CorrTestCS electrochemical workstation (The test was operated with a polarization potential of −0.5 V, a polarization time of 2 min and an open circuit potential detection time of 5 h.

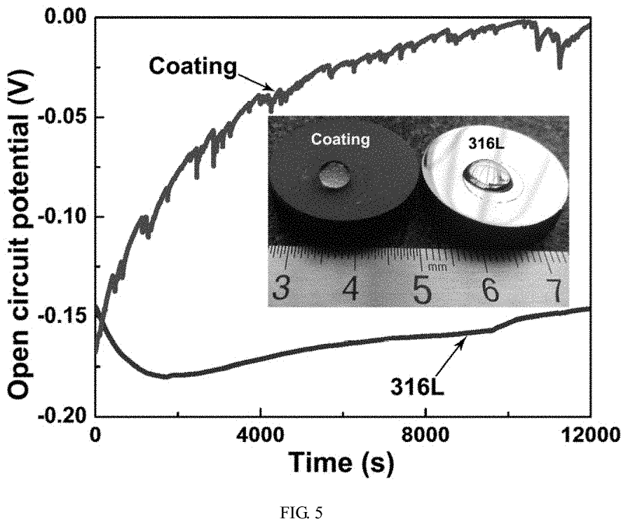

As shown in FIG. 5, the open circuit potential of the substrate without the coating was kept at about −0.16 V, while the open circuit potential of the coating rose to about 0 and was kept at around 0. The open circuit potential of the coating had become stable at 2000 s of the test, which indicated that the tendency of the coating to be corroded was greatly weakened. Therefore, the coating of the disclosure had an excellent corrosion resistance. Moreover, it was also displayed in FIG. 5 that the coating after tested for 12,000 s still had hydrophobicity, which demonstrated the excellent chemical stability of the coating.

Moreover, it should be understood that each of the above-mentioned embodiments does not merely contain one independent technical solution. The embodiments are merely illustrative of the disclosure to make the technical solutions of the disclosure clearer, and the technical solutions in the embodiments can be combined properly to form other embodiments understandable for those skilled in the art. Those embodiments obtained without sparing any creative effort should still fall within the scope of the disclosure.

What is claimed is:

1. A protective coating for a substrate, comprising: a pretreated surface and a composite coating, wherein the composite coating is formed of a mixture of a ZrO₂ powder, a PTFE powder and a silicone powder by spraying.

2. The protective coating of claim 1, wherein the pretreated surface has a rough structure.

3. The protective coating of claim 1, wherein a weight ratio of the ZrO₂ powder to the PTFE powder to the silicone powder is 9-11:0.9-1.1:0.45-0.55.

4. The protective coating of claim 1, wherein the ZrO₂ powder contains 7%-9% by weight of yttrium oxide.

5. The protective coating of claim 1, wherein the ZrO₂ powder has a particle size of 11-125 μm; the PTFE powder has a particle size of 20-60 μm; and the silicone powder has a particle size of 4.0-4.5 μm.

6. The protective coating of claim 2, wherein the substrate is a metal or a ceramic material.

7. The protective coating of claim 1, wherein the composite coating has a thickness of 10-40 μm.

8. A method for preparing the protective coating of claim 1, comprising:
subjecting the substrate to sand blasting to produce the pretreated surface; and
spraying the mixture of the ZrO₂ powder, the PTFE powder and the silicone powder onto the substrate by air plasma spraying.

9. The method of claim 8, further comprising:
mixing the mixture for 2-2.5 h in a rolling-type ball mill; drying the mixture at 90-95° C. in a drying oven for 1-1.5 h; cooling the mixture; and spraying the cooled mixture onto a surface of the substrate with a spray gun;
wherein a moving speed of the spray gun is 440-460 mm/s.

10. The method of claim 8, wherein parameters for the air plasma spraying are set as follows: current: 530-570 A; voltage: 40-50V; power: 20-27.5 KW; compressed air: 0.6-0.7 MPa; feeding rate of carrier gas: 4-6 L/min; feeding rate of the mixture: 20-28 g/min; and spraying distance: 109-111 mm.
